(19) United States
(12) Patent Application Publication
(10) Pub. No.: US 2011/0173910 A1
(43) Pub. Date: Jul. 21, 2011

(54) COMPOSITE ROOFING BOARDS AND METHODS FOR INSTALLING A COMPOSITE ROOFING BOARD

(75) Inventors: Kenneth Franklin, Fayetteville, GA (US); William G. McDonald, Marietta, GA (US)

(73) Assignee: Pactiv Corporation, Lake Forest, IL (US)

(21) Appl. No.: 12/691,405

(22) Filed: Jan. 21, 2010

(51) Int. Cl. E04C 2/24; E04D 3/18; B32B 27/06; B32B 7/04

(52) U.S. Cl. 52/309.1; 52/745.06; 428/41.8; 428/41.5; 428/41.3

(57) ABSTRACT

Composite roofing boards and methods for installing a composite roofing board are presented herein. In one embodiment, the roofing board comprises at least nine layers: two outer polymeric layers; two adhesive layers disposed between the two outer polymeric layers; two inner polymeric layers disposed between the two adhesive layers; and a substrate layer disposed between the two inner polymeric layers. A polymeric adhesive, such as an acrylate-polymer adhesive, is preformed on an outer surface of the first and/or second outer polymeric layer. A removable release liner, such as a siliconized polyester film, covers the polymeric adhesive.

### FIELD OF THE INVENTION

The present invention relates generally to buildings and building roof coverings. More particularly, the present invention relates to composite roofing boards for building roof covering systems and methods for installing composite roofing boards.

### BACKGROUND OF THE INVENTION

Conventional roof structures for commercial and residential buildings typically include a roof support deck, an insulation barrier layer above the support deck, and a weather-resistant outer layer (commonly referred to as a roofing membrane). The three main types of roof coverings are single ply membranes, modified bitumen, and built up roofing. Historically, the roof deck, which acts as the support infrastructure for the roof, was limited to interconnected wood crossbeams (“stick framing”), but more recently has seen wide-spread use of other materials, such as steel girders, cast iron, concrete, and the like.

The insulation layer generally provides the requisite thermal resistance, which is typically specified by local building codes. Insulation boards have conventionally been made from extruded polystyrene or polyisocyanurate, or polyurethane, or expanded polystyrene. Conventionally, insulation boards are attached to the roof structure using what is commonly known as plates and screws.

When existing roof structures come to the end of their service life, they are commonly repaired or roofed over. The replacement of an existing roof covering system is known in the industry as “reroofing”. Some reroofing operations require complete removal and replacement of both the existing insulation barrier and the roofing membrane system. Optionally, an additional layer can be applied directly on top of the original roof structure, which is often referred to as a separator sheet, cover board, or recovery board. These products are typically used when the existing roof structure does not require complete replacement. They serve as a way to separate the old roof from the new roof so that the new roof membrane can be added at a lower cost than if the entire roof were to be replaced. “Recovery boards or cover boards,” as they are referred to in the roofing industry, typically have little or low insulation value and their main purpose is to function as a means to separate the old roof from the new roof. Conventionally, recovery boards are attached to the roof structure using mechanical fasteners, such as plates and screws.

As with conventional separator sheets, most common recovery boards are made of extruded polystyrene, preformed polyurethane, or polyisocyanurate, or expanded polystyrene or a wood-fiber substrate coated with a thin asphaltic facer. Optionally, the fiberboard can be replaced with a rigid gypsum board, which may be glass-fiber-reinforced. To seal and weatherproof the roof structure, the recovery boards, depending on the substrate material, are typically covered with various roofing membranes, including molten asphalt, modified bitumen membrane, rubberized asphalt, or an elastomeric composition such as a ethylenepropylene diene monomer (EPDM), Thermal Plastic Olyefin (TPO) or Polyvinalchloride (PVC). Although relatively inexpensive and generally in wide use, wood-fiber- and perlite or gypsum based recovery boards can be ineffective when moisture is present in the existing roof structure. Wood-fiber boards, in particular, will deteriorate when exposed to moisture.

Currently, the weather-resistant outer layer (or roofing membrane) is attached to the roof using water- or solvent-based adhesives. Liquid adhesives in general can be very messy, require additional tools to apply, and are very difficult to apply evenly. In addition, water-based adhesives cannot be used during very damp or very cold seasons as the adhesive will not dry or may freeze. Many solvent-based adhesives create noxious fumes and contain volatile organic compounds (VOC) that are harmful to the environment.

### SUMMARY OF THE INVENTION

According to one embodiment of the present invention, a composite roofing board for a roof structure is featured. In this embodiment, the composite roofing board comprises first and second polymeric layers, and first and second adhesives disposed between the first and second polymeric layers. In addition, third and fourth polymeric layers are disposed between the first and second adhesives, and a substrate layer is disposed between the third and fourth polymeric layers. A polymeric adhesive is disposed on an outer surface of the first and/or second polymeric layer. Moreover, a removable release liner is disposed on the polymeric adhesive.

According to another embodiment of the present invention, a composite roofing board, such a roofing recovery board, is provided. In this embodiment, the composite roofing board is a preformed, 9-layer laminate construction comprising a rigid substrate layer, such as a polystyrene foam board, and first and second high impact polystyrene (HIPS) layers that are each attached to a respective opposing side of the substrate layer. First and second tie-layers are each attached to a respective one of the first and second HIPS layers, whereas first and second polypropylene layers are each attached to a respective one of the first and second tie-layers. A layer of polymeric adhesive, such as a thermoplastic pressure-sensitive adhesive, is attached to the first and/or second polypropylene layers. A release liner, such as a siliconized polyester film, is removably attached to the outermost surface of the polymeric adhesive layer.

The above summary of the invention is not intended to represent each embodiment, or every aspect, of the present invention. The above features and advantages, and other features and advantages of the present invention, will be readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a schematic side-view illustration of a composite roofing board in accordance with one embodiment of the present invention;

FIG. 2 is a schematic side-view illustration of a composite roofing board in accordance with an alternative embodiment of the present invention; and

FIG. 3 is a schematic side-view illustration of a composite roofing board in accordance with another alternative embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE EMBODIMENTS

While this invention is susceptible of embodiment in many different forms, there is shown in the drawings and will herein be described in detail representative embodiments of the invention with the understanding that the present disclosure is to be considered as an exemplification of the principles of the invention and is not intended to limit the broad aspect of the invention to the embodiments illustrated. To that extent, elements and limitations that are disclosed herein, for example, in the Abstract, Summary of the Invention, and Detailed Description of the Embodiments sections, but not explicitly set forth in the claims, should not be incorporated into the claims, singly or collectively, by implication, inference or otherwise.

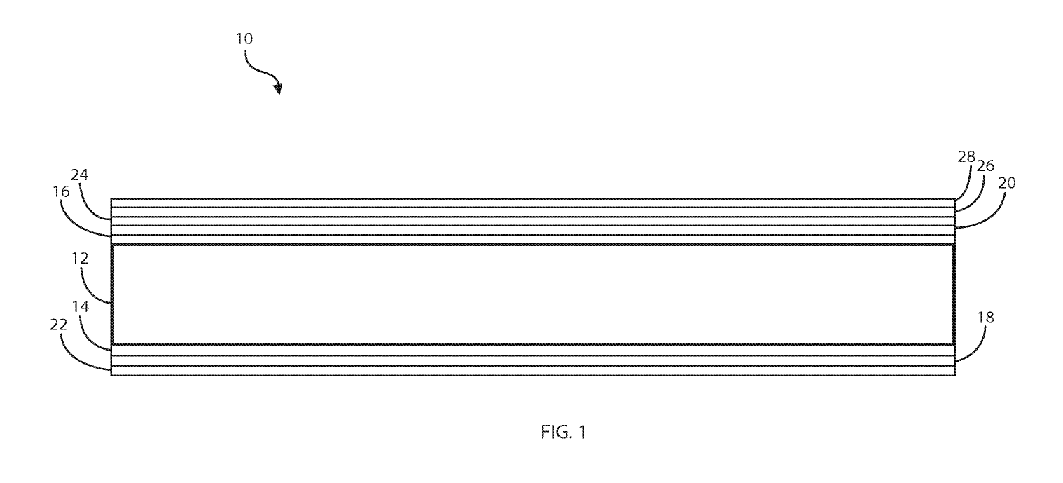

Referring to FIG. 1, a composite roofing board, which is also referred to herein as “recovery board,” is depicted schematically at 10 in accordance with one embodiment of the present invention. In some embodiments, the roofing board 10 is intended as a roofing recovery board for use in “recovering” or “reroofing” a low-slope commercial roof. However, the composite roofing board 10 can be used in other applications, such as, but not limited to, a roofing insulation board or other composite construction boards, without departing from the scope and spirit of the present invention. In addition, the drawings presented herein are not to scale and are provided purely for instructional purposes. As such, the individual and relative dimensions shown in the drawings are not to be considered limiting.

The composite roofing board 10 includes at least three layers, but preferably includes, as shown in FIG. 1, nine layers—i.e., a first layer 12, a second layer 14, a third layer 16, a fourth layer 18, a fifth layer 20, a sixth layer 22, a seventh layer 24, an eighth layer 26 and a ninth layer 28. The first layer 12 of the roofing board 10 in FIG. 1 is located between the second and third layers 14, 16. The first, second and third layers 12, 14, 16 in FIG. 1 are located between the fourth and fifth layers 18, 20. Likewise, the first, second, third, fourth and fifth layers 12, 14, 16, 18, 20 in FIG. 1 are located between the sixth and seventh layers 22, 24. The eighth layer 26 is located between the seventh layer 24 and the ninth layer 28.

In some embodiments, the second and third layers 14, 16 span substantially the entirety of (i.e., are coextensive with) and are each attached directly to a respective opposing outer surface of the first layer 12. Likewise, the fourth layer 18 spans substantially the entirety of and is attached directly to the outer surface of the second layer 14, in opposing spaced relation to the first layer 12. The fifth layer 20 spans substantially the entirety of and is attached directly to the outer surface of the third layer 16, in opposing spaced relation to the first layer 12. Similarly, the sixth layer 22 spans substantially the entirety of and is attached directly to the outer surface of the fourth layer 18, whereas the seventh layer 24 spans substantially the entirety of and is attached directly to the outer surface of the fifth layer 20. Finally, in the embodiment illustrated in FIG. 1, the eighth layer 26 spans substantially the entirety of and is attached directly to the outer surface of the seventh layer 24, while the ninth layer 28 spans substantially the entirety of and is attached directly to the outer surface of the eighth layer 26.

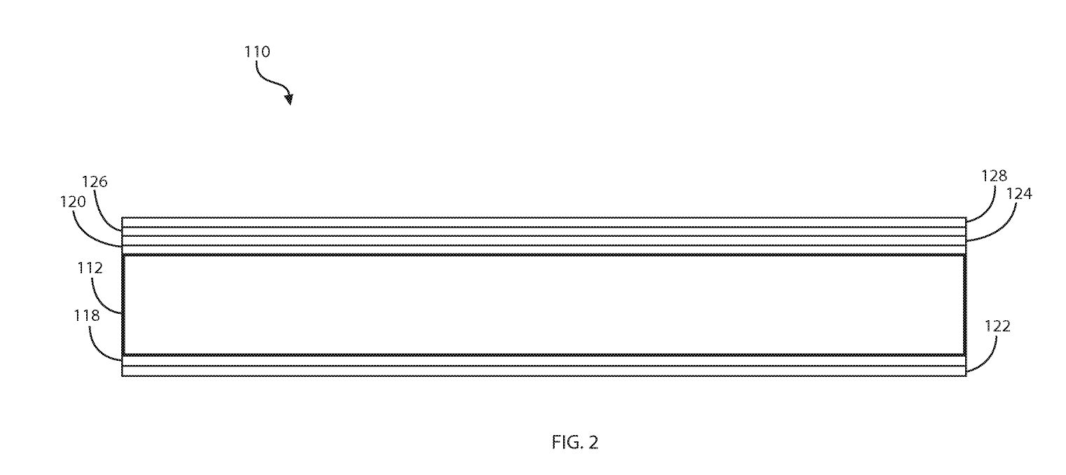

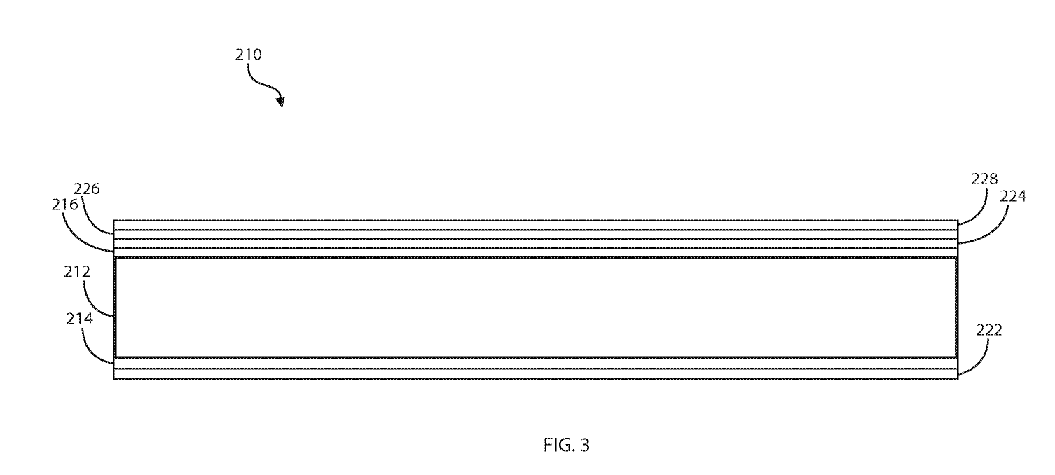

It is contemplated that the composite roofing board 10 may include additional or fewer layers than the 9-layer construction shown in FIG. 1. Other roofing board embodiments are illustrated, for example, in FIGS. 2 and 3. The composite roofing board 10 may comprise additional adhesive layers, reinforcement layers (e.g., glass-strand or glass-fiber reinforced polymers), and optional laminated surface coatings or “facers” (e.g., paper, aluminum foil, reinforced polymeric materials, reinforced cellulosic materials, and combinations thereof). In contrast, it may be possible to eliminate the second and third layers 14, 16 and bond the sixth and seventh layers 22, 24 directly to the first layer 12 via the fourth and fifth layers 18, 20, as will be readily apparent from the discussion presented below with respect to the exemplary embodiment presented in FIG. 2. To that end, it may also be possible to eliminate the fourth and fifth layers 18, 20, and bond the sixth and seventh layers 22, 24 directly to the second and third layers 14, 16, as discussed below with respect to the exemplary embodiment presented in FIG. 3. Moreover, the layers illustrated and discussed herein can be reordered without departing from the intended scope and spirit of the present invention.

FIGS. 2 and 3 illustrate additional composite roofing board configurations in accordance with optional embodiments of the present invention. Like reference numerals are used in FIGS. 2 and 3 (designated with 100-series and 200-series reference numerals, respectively) to indicate similar structure from FIG. 1. It should also be noted that the use of the term “layer” in the description and claims does not necessarily require that particular segment of the composite construction span the entirety of (i.e., be coextensive with) all remaining layers unless otherwise explicitly stated in the claims.

According to certain aspects of the present invention, the composite roofing board 10 is fabricated as a preassembled laminated-composite structure. In the embodiment shown in FIG. 1, for example, the roofing board 10 may be constructed with all nine layers prefabricated as a unitary structure. In general, the composite roofing board 10 is from about 40.6 cm (16 inches) to about 152.4 cm (60 inches) wide, and from about 121.9 cm (48 inches) to about 304.8 cm (120 inches) long. According to one preferred embodiment, each composite roofing board 10 is approximately 121.9 cm (48 inches) wide by approximately 243.8 cm (96 inches) long. Moreover, the roofing board 10 is approximately 6.35 mm (0.25 inches) to about 101.6 mm (4.0 inches) thick, depending upon the intended application. According to one preferred embodiment, the roofing board 10 is approximately 9.53 mm (0.375 inches) thick. The thermal resistance (commonly referred to as the “R-value”) of the composite board 10 may be modified, for example, to suit the intended application thereof. For instance, in roofing recovery board applications, the R-value of the composite roofing board 10 may be between about 1.0 and 23.0.

The first layer 12 (also referred to herein as “substrate”) may be formed from any material with the necessary stiffness, structural durability, and functional characteristics required for the intended application of the composite roofing board 10. By way of example, and not limitation, the first layer 12 may be formed from wood-fiber, perlite, gypsum, polystyrene (e.g., extruded or expanded), polyurethane, polypropylene, polyisocyanurate, alkenyl aromatic polymers, polyethylene terephthalate, and combinations thereof. According one embodiment, the first layer 12 is formed by extrusion using an alkenyl aromatic polymer, such as a polystyrenic resin. Depending upon application and cost constraints, polystyrenic resins may be preferred because they provide more stiffness for the composite roofing board 10 than other materials, such as polyethylene. Also, polystyrenic resins are more economical to use than other contemplated resins in forming the first layer 12. In some embodiments, the first layer 12 of the composite board 10 is generally from about 3.0 mm (0.12 inches) thick to about 16 mm (0.625 inches) thick. For example, in an exemplary recovery board application, the first layer 12 is about 6.35 mm (0.25 inches), whereas in an exemplary insulation board application, the first layer 12 is to about 25.4 mm (1 inch) thick.

With continuing reference to FIG. 1, the second and third layers 14, 16 are preferably formed from a polymeric material, such as, but not limited to, polystyrene, polypropylene, polyethylene, alkenyl aromatic polymers, polyolefins, polyesters, and combinations thereof. According to one exemplary configuration, the second and third layers 14, 16 are fabricated from an impact polystyrene, such as high impact polystyrene (HIPS). In general, polystyrene is a thermoplastic aromatic polymer made from the aromatic monomer styrene. Polystyrene may include, in some arrangements, homopolymers of styrene, and styrene copolymers comprised of at least 50 mole percent of a styrene unit (preferably at least about 70 mole percent) and a minor (i.e., less than 50%) proportion of a monomer copolymerizable with styrene. Polystyrene may also include, in other arrangements, blends of at least 50 percent by weight of the styrene homopolymer (preferably at least about 60 weight percent) with another predominately styrenic copolymer. Although preferable, it is not necessary, in practice, that the second and third layers 14, 16 be fabricated from the same material.

Impact polystyrenes are generally classified as medium impact polystyrene (MIPS), high impact polystyrene (HIPS), or super high impact polystyrene (S-HIPS). The butadiene level of the impact polystyrene is preferably in the range from about 3 to about 10 weight percent of the copolymer (butadiene and polystyrene). Each of the second and third layers 14, 16 may be from about 0.0127 mm (0.0005 inches) to about 0.051 mm (0.002 inches) in thickness. According to one preferred embodiment, each of the second and third layers 14, 16 has a thickness of approximately 0.048 mm (0.002 inches) thick. It is also contemplated that the second and third layers 14, 16 may be single or biaxially oriented, and colored or noncolored. The term “single oriented” as used herein indicates that the material is oriented (e.g., stretched) primarily in a single direction, whereas the term “biaxially oriented” as used herein indicates that the material is oriented primarily in two directions.

The fourth and fifth layers 18, 20 of the composite roofing board 10, which are disposed between the sixth and seventh layers 22, 24, are preferably adhesives or adhesive mixtures. By way of example, and not limitation, the fourth and fifth layers 18, 20 may comprise ethylene vinyl acetate (EVA), modified EVA, anhydride-modified EVA, acid- or acrylate-modified EVA, modified ethylene acrylate, acid-modified ethylene acrylate, anhydride-modified ethylene acrylate, anhydride-modified high-density polyethylene, anhydride-modified low-density polyethylene, and a polypropylene-based mixture. In some embodiments, the fourth and fifth layers 18, 20 are tie-layer adhesives. It may be preferable, in certain applications, to use an anhydride-modified linear low-density polyethylene. It is not necessary, however, that the fourth and fifth layers 18, 20 be fabricated from the exact same material. Moreover, as indicated above, the tie-layer adhesives need not span the entirety of the respective layers to which they are attached and attaching to practice the present invention.

Continuing with the above example, these two adhesive layers promote bonding between the second and sixth layers 14, 22 and the third and seventh layers 16, 24, respectively. In particular, each anhydride-modified tie-layer adhesive 18, 20 bonds a biaxially-oriented polypropylene film (BOPP) layer 22, 24 to a respective HIPS layer 14, 16. It may be possible, as mentioned above, to eliminate the second and third layers 14, 16 from the composite structure 10. For example, as seen in FIG. 2, the sixth and seventh layers 122 and 124, respectively, of the composite roofing board 110 are each attached directly to the substrate 112 via a respective adhesive layer 118, 120, with the eighth layer 126 located between the seventh layer 124 and the ninth layer 128. Optionally, the adhesive layers 18, 20 may also be eliminated if, for instance, the sixth and seventh layers 22, 24 are fabricated from a polystyrene film that can be heat-laminated directly to the substrate 12 or a respective HIPS layer 14, 16. For example, as seen in FIG. 3, the sixth and seventh layers 222 and 224, respectively, of the composite roofing board 210, are each attached directly to a respective layer 214, 216, with the eighth layer 226 located between the seventh layer 224 and the ninth layer 228. In general, the fourth and fifth layers 18, are each approximately 0.01 mm (0.0004 inches) to approximately 0.05 mm (0.002 inches) thick, with a preferred thickness of approximately 0.0117 mm (0.0005 inches). Optionally, the fourth and fifth layers 18, 20 each have a density of approximately 0.88 g/cc to approximately 0.98 g/cc, with a preferred density of approximately 0.933 g/cc.

The sixth and seventh layers 22, 24 are preferably fabricated from a polymeric material, such as, for example, polyethylene, polypropylene, polystyrene, polyethylene terephthalate (PET), polyvinyl chloride (PVC), polyamide, and combinations thereof. In one preferred embodiment, the sixth and seventh layers 22, 24 comprise biaxially-oriented polypropylene (BOPP). In particular, the BOPP may be a co-extruded, non-heat sealable, biaxially oriented film. Although preferable, it is not necessary, in practice, that the sixth and seventh layers 22, 24 be fabricated from the same, identical material. In the illustrated example, the BOPP layers 22, 24 allow the substrate 12 to obtain a preferred wind uplift resistance, as explained hereinbelow.

Each of the sixth and seventh layers 22, 24 may be approximately 0.0178 mm (0.0007 inches) to approximately 0.127 mm (0.005 inches) thick, with a preferred thickness of approximately 0.025 mm (0.001 inches). The tensile strength of the BOPP layers 22, 24, as measured, for example, by ASTM D-882 (established by the American Society for Testing and Materials) is at least 5,000 pounds per square inch (psi) in the machine direction and 4,000 psi in the transverse direction. Depending upon the intended application, the tensile strength is at least about 10,000 psi, and preferably approximately 20,000 psi in the machine direction, whereas in the transverse direction, the tensile strength is at least about 16,000 psi, and preferably approximately 32,000 psi.

With continuing reference to FIG. 1, the eighth layer 26 is preferably a polymeric adhesive that exhibits sufficient bonding strength to operatively adhere a weather-resistant outer layer directly to the composite roofing board 10, and preferably retain the weather-resistant outer layer thereon without additional fasteners or adhesive. By way of clarification, the polymeric adhesive may include, for example, rubberized asphalt, butyl rubber, vinyl acetate, and ethylene vinyl acetate (EVA). In some preferred embodiments, the eight layer 26 comprises a pressure-sensitive thermoplastic hot-melt adhesive, such as an acrylate polymer adhesive. The eighth layer 26 is approximately 0.025 mm (0.001 inches) to approximately 0.51 mm (0.02 inches) thick. According to one preferred embodiment, the eighth layer 26 is approximately 0.051 mm (0.002 inches) thick. It is also envisioned that the composite roofing board 10 be fabricated with an additional polymeric adhesive layer on the opposite side of the laminate construction (i.e., attached to the outer surface of the sixth layer 22) such that, for example, the composite roofing board 10 may be quickly and easily attached directly to the structural roof deck or other element within the existing roofing system.

The ninth layer 28 of the composite roofing board 10 is a release liner, which covers and protects the eighth layer 26. The ninth layer 28 may comprise siliconized polypropylene, siliconized polyethylene, siliconized paper, clay coated paper, poly coated paper, and combinations thereof. In some embodiments, the ninth layer 28 comprises a siliconized polyester. The release liner is approximately 0.025 mm (0.001 inches) to approximately 0.076 mm (0.003 inches) thick, with a preferred thickness of approximately 0.051 mm (0.002 inches).

The composite roofing board 10 may be a roofing recovery board for use in low slope commercial roofing that creates a receptive surface for attaching roofing membranes. Rather than requiring a contractor or roofer to purchase and apply a plethora of mechanical fasteners, such as nails, foam, solvent- or water-based adhesives, the self-adhering composite constructions disclosed herein are provided with an integrally-formed layer of adhesive with sufficient bonding strength to operatively attach the composite roofing board 10 to the roof structure. The composite roofing board 10 can therefore completely eliminate mechanical fasteners (no added roof penetrations), which significantly reduces entry of moisture which may otherwise compromise the roofing system. The roofing board construction is also suitable for applications where it is desirable to install an underlayment or foam plastic sheathing without through penetrations, i.e., water proofing membranes, air barriers, etc. The composite roofing board 10 is preferably lightweight (e.g., adding only 1/10 lb/square foot to the roof), easy to cut, easy to handle and install, and requires little or no clean up. Furthermore, the composite roofing board 10 preferably does not absorb moisture, and has no volatile organic compounds (VOC). The composite roofing board 10 of the present invention will therefore speed application time, reduce manual labor requirements, and decrease installation costs.

Large wind speeds may cause roof damage by creating sizeable pressure gradients over the roof (i.e., the air pressure below the roofing assembly is greater than the air pressure above the roof assembly), which cause shear and tensile forces that can tear the assembly apart. As wind flows over a building, the pressure directly above the surface of the roof decreases, while internal air pressure increases due to air infiltration through openings, cracks, etc. The result is a net upward force on the roofing system. This force is referred to as “wind uplift.” It may be desirable in some embodiments that the composite roofing board 10 exhibit a minimum uplift resistance of approximately 60 pounds per square foot (lbs./sq. ft.), which corresponds to a Factory Mutual (FM) wind uplift rating of 1-60 when tested according to FM 4470 “Approval Standard for Class 1 Roof Covers”. In one preferred embodiment, the composite roofing board 10 exhibits a minimum uplift resistance of approximately 120 lbs./sq. ft. and, in other preferred embodiments, a minimum uplift resistance of approximately 450 lbs./sq. ft. to approximately 840 lbs./sq. ft.

In some embodiments, the flexural strength of the composite roofing board 10, as measured, for example, by ASTM D1037 or ASTM C203 (Method 1, Procedure A), without the ninth layer 28 (e.g., with the release liner removed) is a 180 psi minimum flexural stress with a 13,000 psi minimum flexural modulus in the machine direction, and a 180 psi minimum flexural stress with a 20,000 psi minimum flexural modulus in the transverse direction.

Improved methods for attaching a weather resistant outer membrane to a roofing construction are also presented herein. In an exemplary embodiment, the method comprises providing a composite roofing board 10 with a substrate layer 12, such as a polystyrene foam core, and a polymeric adhesive layer 26, such as an acrylic-polymer pressure-sensitive adhesive (PSA), preformed to the substrate layer 12. A release liner 28, such as a thin sheet of siliconized polyester, removably covers the polymeric adhesive layer 26. The polymeric adhesive layer 26 exhibits sufficient bonding strength to adhere the weather-resistant outer layer to the composite roofing board 10.

The composite roofing board 10 is mounted to the existing roof structure (e.g., via plates and screws). The method further comprises removing the release liner 28 from the composite roofing board 10, and attaching the weather-resistant outer layer to the composite roofing board 10 via the polymeric adhesive layer. In other words, attaching the weather-resistant outer layer to the composite laminate board 10 merely requires removing the release liner 28, placing the weather-resistant outer layer on the polymeric adhesive layer 26, and applying pressure (e.g., via hand or a roller) to an outer surface of the weather-resistant outer layer. As such, there is no need for using additional mechanical fasteners or applying additional adhesives for attaching the weather-resistant outer layer to the composite roofing board

The methods of the present invention are described with respect to the structure illustrated in FIG. 1; however, the claimed methods of the present invention are not limited to the composite roofing board 10 depicted herein. Moreover, the foregoing exemplary method preferably includes those steps enumerated above; however, it is within the scope and spirit of the present invention to omit steps, include additional steps, and/or modify the order presented herein. It should be further noted that the above method represents a single sequence to install a single composite roofing board. However, it is expected that the method be carried out repeatedly and systematically to install a plurality of composite roofing boards.

While the best modes for carrying out the present invention have been described in detail, those familiar with the art to which this invention relates will recognize various alternative designs and embodiments for practicing the invention within the scope of the appended claims.

1. A composite roofing board for a roof structure having a weather-resistant outer layer, the composite roofing board comprising:
at least two polymeric layers;
a substrate layer disposed between the at least two polymeric layers;
a polymeric adhesive located on an outer surface of at least one of the at least two polymeric layers; and
a release liner on the polymeric adhesive;
wherein, upon removal of the release liner, the polymeric adhesive exhibits sufficient bonding strength to adhere the weather-resistant outer layer to the composite roofing board.

2. The composite roofing board of claim 1, wherein the polymeric adhesive comprises a thermoplastic pressure-sensitive adhesive.

3. The composite roofing board of claim 1, wherein the polymeric adhesive comprises an acrylate-polymer adhesive.

4. The composite roofing board of claim 1, wherein the release liner comprises a siliconized polyester.

5. The composite roofing board of claim 1, wherein the substrate layer comprises at least one of a wood fiber, a polystyrene foam, a polyurethane foam, and a polypropylene foam.

6. The composite roofing board of claim 1, wherein the composite roofing board exhibits a minimum uplift resistance of at least 60 lbs./sq. ft.

7. The composite roofing board of claim 1, wherein the at least two polymeric layers includes first and second polymeric layers each comprising a high impact polystyrene (HIPS).

8. The composite roofing board of claim 1, further comprising first and second adhesive layers between the at least two polymeric layers.

9. The composite roofing board of claim 8, wherein the first and second adhesive layers each comprise an anhydride-modified linear low-density polyethylene adhesive.

10. The composite roofing board of claim 1, wherein the at least two polymeric layers includes first and second polymeric layers each comprising a biaxially-oriented polypropylene (BOPP).

11. The composite roofing board of claim 10, wherein the tensile strength of the first and second BOPP polymeric layers is at least 5,000 psi in the machine direction and at least 4,000 psi in the transverse direction.

12. The composite roofing board of claim 10, wherein the tensile strength of the first and second BOPP polymeric layers is at least 20,000 psi in the machine direction and at least 32,000 psi in the transverse direction.

13. The composite roofing board of claim 1, wherein the composite roofing board is a preassembled unitary structure.

14. The composite roofing board of claim 1, wherein the composite roofing board has a minimum flexural stress of approximately 180 psi in the machine direction and transverse direction, and a minimum flexural modulus of approximately 13,000 psi in the machine direction and approximately 20,000 psi in the transverse direction.

15. A composite recovery board, comprising:
a substrate layer;
first and second impact polystyrene layers each attached to a respective opposing side of the substrate layer;
first and second adhesives each attached to a respective one of the first and second impact polystyrene layers;
first and second polypropylene layers each attached to a respective one of the first and second adhesives;
a polymeric adhesive attached to at least one of the first and second polypropylene layers; and
a release liner removably attached to an outermost surface of the polymeric adhesive.

16. A method for attaching a roofing membrane to a composite roofing board, the method comprising:
providing a composite roofing board with a substrate layer, a polymeric adhesive preformed to the composite roofing board, and a release liner removably covering substantially all of the polymeric adhesive layer;
mounting the composite roofing board to a roof structure;
removing the release liner from the composite roofing board; and
attaching the weather-resistant outer layer to the composite roofing board via the polymeric adhesive layer.

17. The method of claim 16, characterized by the absence of applying mechanical fasteners for attaching the weather-resistant outer layer to the composite roofing board.

18. The method of claim 16, characterized by the absence of applying an additional adhesive for attaching the weather-resistant outer layer to the composite roofing board.

19. The method of claim 16, wherein the composite roofing board exhibits a minimum uplift resistance of at least 120 lbs./sq. ft.

20. The method of claim 16, wherein the composite roofing board further comprises:
first and second high impact polystyrene (HIPS) layers each attached to a respective opposing side of the substrate layer;
first and second tie-layer adhesives each attached to a respective one of the first and second HIPS layers; and
first and second biaxially-oriented polypropylene (BOPP) layers each attached to a respective one of the first and second tie-layer adhesives.
